(19) United States
(12) Patent Application Publication
(10) Pub. No.: US 2023/0411717 A1
(43) Pub. Date: Dec. 21, 2023

(54) BATTERY UNIT WITH INTERNAL TEMPERATURE MONITORING MEANS

(71) Applicant: Elentec., LTD, Hwaseong-si (KR)

(72) Inventor: Seung Tae JUNG, Hwasung-si (KR)

(73) Assignee: Elentec., LTD, Hwaseong-si (KR)

(21) Appl. No.: 18/070,520

(22) Filed: Nov. 29, 2022

(30) Foreign Application Priority Data
Jun. 20, 2022 (KR) 10-2022-0075053

(51) Int. Cl. H01M 10/48; H01M 50/213; H01M 50/271; H01M 50/298; H01M 50/507

(52) U.S. Cl. CPC H01M 10/486; H01M 10/482; H01M 50/213; H01M 50/271; H01M 50/298; H01M 50/507

(57) ABSTRACT

Proposed is a battery unit in which a plurality of cylindrical battery cells, each of which has an upper surface provided with a positive electrode and a negative electrode, are mounted in rows and columns, the battery unit including a lower housing in which a plurality of support recesses supporting the plurality of battery cells are formed in rows and columns and are spaced apart each other, an upper housing coupled to the lower housing and having a plurality of straight removal regions in which regions corresponding to the upper surfaces of the plurality of battery cells are connected each other, an electrode network provided on an upper surface of the upper housing and provided as a plurality of busbars, and a ring-shaped temperature sensor coupled to at least one of the plurality of battery cells and sensing temperature in an inner space formed by the lower and upper housings.

### CROSS REFERENCE TO RELATED APPLICATION

The present application claims priority to Korean Patent Application No. 10-2022-0075053, filed Jun. 20, 2022, the entire contents of which is incorporated herein for all purposes by this reference.

### BACKGROUND OF THE INVENTION

### Field of the Invention

The present disclosure relates to a battery unit with an internal temperature monitoring means.

### Description of the Related Art

With the spread of smart devices, the use of rechargeable and reusable secondary batteries is also increasing.

Recently, such secondary batteries have been increasingly applied to electric vehicles (EVs) such as electric cars and electric trains, and an energy storage system (ESS) for industrial and home use.

An ESS is a system technology that increases energy efficiency through charging (storage) and discharging (use) of energy storage devices. The energy storage devices are generally composed of a battery unit in a form in which a plurality of unit lithium-ion battery cells are mounted in a housing and then electrically connected. An example of such a battery unit structure technology is disclosed in Korean Patent No. 10-1724770 (application date: Jun. 4, 2010, publication date: Apr. 3, 2017, hereinafter referred to as the “related art”).

In the case of a battery unit, because a plurality of battery cells are densely packed, it is required to adopt a structure for effectively lowering heat generated during charging/discharging of battery cells to thereby prevent deterioration of charging/discharging efficiency of the battery cells caused by temperature change. To this end, there is a need for precise temperature sensing in the inner space in which the battery cells are mounted.

However, the related art is not provided with a means for detecting the temperature change of the battery unit, and even when such a temperature monitoring means is applied, it is difficult to monitor the temperature in a battery cell mounting region. In addition, when the temperature monitoring means is disposed inside the battery unit, the overall size of the battery unit inevitably increases in order to secure an installation space for the temperature monitoring means.

The foregoing is intended merely to aid in the understanding of the background of the present disclosure, and is not intended to mean that the present disclosure falls within the purview of the related art that is already known to those skilled in the art.

### SUMMARY OF THE INVENTION

Accordingly, the present disclosure has been made keeping in mind the above problems occurring in the related art, and the present disclosure provides a battery unit with an internal temperature monitoring means, the battery unit being capable of precise temperature monitoring in a battery cell mounting region while minimizing interference in a battery cell arrangement section.

In order to achieve the above objective, according to one aspect of the present disclosure, there is provided a battery unit in which a plurality of cylindrical battery cells, each of which has an upper surface provided with a positive electrode and a negative electrode, are mounted in rows and columns, the battery unit including: a lower housing in which a plurality of support recesses, each of which supports each of the plurality of battery cells while surrounding a lower surface of the battery cell and a portion of an outer periphery of the battery cell close to the lower surface, are formed in rows and columns and are spaced apart from each other; an upper housing coupled to top of the lower housing and having a plurality of straight removal regions in which regions corresponding to the respective upper surfaces of the plurality of battery cells supported in the lower housing are connected to each other; an electrode network provided on an upper surface of the upper housing and provided as a plurality of busbars selectively connected to the respective positive electrodes of the plurality of battery cells exposed through the removal regions; and a temperature sensor provided in a ring shape coupled to at least one battery cell of the plurality of battery cells while surrounding an outside thereof, and configured to sense a temperature in an inner space formed by the lower housing and the upper housing.

Here, the lower housing may include: a tray part provided in a quadrangular tray shape having an open upper surface having an inner space in which the plurality of battery cells are arranged; and a plurality of rhombic protrusions protruding upward from a bottom surface of the inner space of the tray part.

Furthermore, the plurality of protrusions may be spaced apart from each other at a predetermined interval to form rows and columns, and at least two or more adjacent protrusions may form each of the support recesses, wherein the support recesses support the battery cells in contact with the portion of the outer periphery of each of the battery cells close to the lower surface thereof.

Moreover, the plurality of protrusions may have a predetermined thickness in row and column directions so that a specific battery cell and another battery cell adjacent thereto in the row or column direction are supported in a state of being spaced apart from each other at a regular interval.

In addition, the temperature sensor may include: a coupling part provided in a “C” shape, and fitted over and coupled to the outside of the battery cell; an extended part protruding from an outside of the coupling part in a horizontal direction, and having a predetermined insertion recess; and a sensor part inserted into the insertion recess formed in the extended part, and configured to sense the temperature.

Here, the coupling part may have a thickness less than an interval between the battery cell to be coupled and another battery cell adjacent thereto in the row or column direction.

Furthermore, the extended part may protrude to a height smaller than a diagonal width of the protrusions formed on the lower housing.

In addition, the coupling part may be fitted over and coupled to the battery cell while surrounding the outside thereof in a state in which the extended part is positioned on top of the protrusions.

According to the battery unit with the internal temperature monitoring means according to the present disclosure, since the coupling part having a thickness less than the minimum interval between the battery cells is coupled to the battery cell in a state in which the extended part is positioned in the space formed between the battery cells, the sensor part is fixed at a position near the battery cell in the inner space formed by the lower housing and the upper housing coupled to each other. Thus, it is possible to enable precise temperature monitoring to be performed according to the degree of heat generated by the battery cells of the battery unit and the cooling performance, without the need for securing an additional installation space required for internal temperature monitoring.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 a view schematically illustrating a battery unit with an internal temperature monitoring means according to an exemplary embodiment of the present disclosure;

FIG. 2 is a view illustrating a temperature sensor fixed on a battery cell supported by a lower housing of the battery unit with the internal temperature monitoring means according to the exemplary embodiment of the present disclosure; and

FIG. 3 shows views (A) and (B) visually illustrating the arrangement position of an extended part of the temperature sensor fixed to the battery unit with the internal temperature monitoring means according to the exemplary embodiment of the present disclosure.

### DETAILED DESCRIPTION OF THE INVENTION

Hereinafter, an exemplary embodiment of a battery unit with an internal temperature monitoring means according to the present disclosure will be described in detail with reference to the accompanying drawings.

Throughout the drawings, like reference numerals refer to like parts. Specific structural and functional descriptions of embodiments of the present disclosure disclosed herein are only for illustrative purposes of the embodiments of the present disclosure. Unless otherwise defined, all terms including technical and scientific terms used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

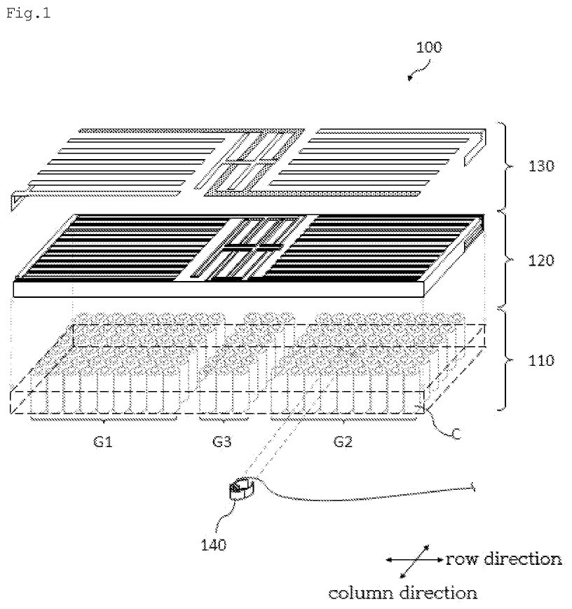

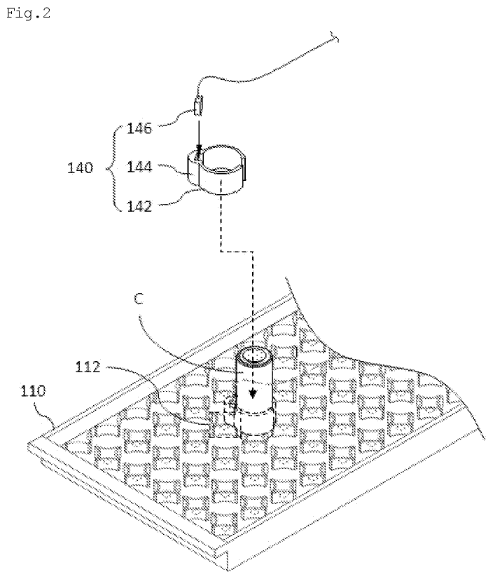

FIG. 1 a view schematically illustrating a battery unit 100 with an internal temperature monitoring means according to an exemplary embodiment of the present disclosure. FIG. 2 is a view illustrating a temperature sensor 140 fixed on a battery cell C supported by a lower housing 110 of the battery unit 100 with the internal temperature monitoring means according to the exemplary embodiment of the present disclosure

Referring to FIGS. 1 to 2, the battery unit 100 with the internal temperature monitoring means according to the exemplary embodiment of the present disclosure may include a lower housing 110, an upper housing 120, an electrode network 130, and the temperature sensor 140.

The lower housing 110 may be provided in a quadrangular basket shape having an open upper surface and having an inner space in which a plurality of cylindrical battery cells C, each of which has an upper surface provided with a positive electrode and a negative electrode, are fixedly arranged to form rows and columns in a predetermined group. A plurality of support recesses (not illustrated) for supporting lower portions of the plurality of battery cells C may be formed in a bottom surface of the inner space in which the plurality of battery cells C are fixedly arranged. Here, the support recesses may be formed by a plurality of rhombic protrusions 112 formed on the bottom surface of the lower housing 110 to be continuously spaced apart along the row and column directions. In more detail, the protrusions 112 may be spaced apart from each other at a predetermined interval to form rows and columns, and at least two or more adjacent protrusions 112 may form a support recess for supporting a battery cell C in contact with a portion of the outer periphery of the battery cell C close to a lower surface thereof. The protrusions 112 may have a predetermined thickness in the row and column directions so that a specific battery cell and another battery cell adjacent in the row or column direction to the specific battery cell are supported in a state of being spaced apart from each other at a regular interval. The protrusions 112 may fix the battery cells C in a vertical state from the bottom surface of the lower housing 110. Due to a spaced apart arrangement of the protrusions 112, the support recesses may be provided in a shape in which a circular or square recess relatively depressed compared to a protruding shape of the protrusions 112 is repeatedly formed in the bottom surface of the lower housing 120 in the row and column directions of the lower housing 120. The support recesses may be formed at a predetermined interval so that the battery cells C are spaced apart from each other at a predetermined interval. At this time, a circulation hole 112a for communicating with a lower side of the lower housing 110 may be formed in the center of each of the protrusions 112.

The plurality of battery cells C fixedly arranged in the lower housing 110 by the plurality of protrusions 112 may form a plurality of cell groups G1, G2, and G3 in each of which a predetermined number of battery cells C form rows and columns. The plurality of battery cells C may be fixed in such a manner that the cell groups G1, G2, and G3 are spaced apart from each other at a predetermined interval along the longitudinal direction of the lower housing 110. At this time, the cell groups G1, G2, and G3 formed by the plurality of battery cells C may be composed of a first cell group G1, a second cell group G2, and a third cell group G3 arranged along the longitudinal direction of the lower housing 110. The first cell group G1 may include a plurality of battery cells C arranged to form rows and columns, and may be disposed in a first region of the inner space of the lower housing 110. The second cell group G2 may include a plurality of battery cells C of the same number as those of the first cell group G1 arranged to form rows and columns, and may be disposed between the first cell group G1 and the second cell group G2. The third cell group G3 may include a plurality of battery cells C of a smaller number than those of the first cell group G1 or the second cell group G2 arranged to form rows and columns, and may be disposed in a second region of the inner space of the lower housing 110 opposite to the first region in which the first cell group G1 is disposed. The arrangement of the first, second, and third cell groups G1, G2, and G3 may be achieved in such a manner that the battery cells C forming a single row or column are connected to each other in parallel, with the positive electrodes thereof being joined to the electrode network 130 in the form of a plurality of separated busbars of various shapes, and the parallel-connected battery cells C in each row or column are connected in series with the parallel-connected battery cells C in another adjacent row or column. The arrangement of the first, second, and third cell groups G1, G2, and G3 may be determined differently depending on the voltage and current flowing through opposite ends of the electrode network 130 connecting the plurality of battery cells C.

The upper housing 120 may be coupled to the lower housing 110 to cover the open upper surface of the lower housing 110. At this time, the upper housing 120 may be coupled to the open upper surface of the lower housing 120, thereby forming a rectangular parallelepiped shape conforming to the shape of the battery unit 100 according to the exemplary embodiment of the present disclosure. The upper housing 120 may be provided in a shape in which a region of an upper portion thereof corresponding to the upper surface of each of the battery cells C on which the positive electrode is disposed is removed. Each removal region may be connected to another adjacent removal region to form a straight line. The upper housing 120 may be provided in a shape in which a region corresponding to an imaginary straight line that connects the upper surfaces of a row of battery cells C forming each of the first cell group G1 and the second cell group G2 is removed, and a region corresponding to an imaginary straight line that connects the upper surfaces of a column of battery cells C forming the third cell group G3 is removed. The removal regions of the upper housing 120 may be provided to allow, when the electrode network 130 which will be described later is disposed on the upper surface of the upper housing 120, the positive electrodes of the plurality of battery cells C arranged in an inner space formed by the lower housing 110 and the upper housing 120 to be joined and connected to a plurality of busbars forming the electrode network 130. The removal regions of the upper housing 120 may be used to dissipate heat generated from the plurality of battery cells C arranged in the inner space formed by the lower housing 110 and the upper housing 120 to the outside. At this time, air in the inner space (battery cell mounting region) formed by the lower housing 110 and the upper housing 120 coupled to each other may be circulated through the respective circulation holes 112a formed in the protrusions 112 of the lower housing 110 and the removal regions formed on the upper surface of the upper housing 120. In other words, natural air cooling may be achieved. Meanwhile, a sensing PCB (not illustrated) that selectively conducts with the plurality of separated busbars of the electrode network 130 and outputs an electrical signal for each connection section of the electrode network 130 to which the plurality of battery cells C are connected may be coupled by a separate coupling means to the center of the upper surface of the upper housing 120 corresponding to the region in which the third cell group G3 is disposed.

The electrode network 130 may be disposed in a region of the upper surface of the upper housing 120 except for the removal regions. The electrode network 130 may include a first busbar (not illustrated), a second busbar (not illustrated), and a third busbar (not illustrated). Here, the first busbar may be provided as a pair of first busbars. The first busbars may be arranged between a plurality of straight removal regions formed in the region corresponding to each of the first cell group G1 and the second cell group G2 of the upper housing 120. The second busbar may include a pair of separated busbars (not illustrated) and a connection busbar (not illustrated). Here, among the pair of separated busbars, one separated busbar may be disposed in any one of the outermost regions of the plurality of straight removal regions formed in the region corresponding to the first cell group G1, and any one or more of a plurality of separated removal regions extending from the any one of the outermost regions and formed in the region corresponding to the third cell group G3; and the remaining separated busbar may be disposed at a position diagonal and symmetrical with the position of the one separation busbar, that is, in any one of the outermost regions of the plurality of straight removal regions formed in the region corresponding to the second cell group G2, and any one or more of the plurality of separated removal regions extending from the any one of the outermost regions and formed in the region corresponding to the third cell group G3. The connection busbar may be disposed in the region in which no separated busbars are arranged among the regions adjacent to the separated removal regions formed in the region corresponding to the third cell group G3. The third busbar may be provided as a pair of third busbars. The third busbars may be respectively formed in the outermost region of the plurality of straight removal regions formed in the region corresponding to the first cell group G1 and the outermost region of the plurality of straight removal regions formed in the region corresponding to the second cell group G2, the outermost regions being not connected to the first and second busbars. The third busbars may extend in the lateral direction of the upper housing 110.

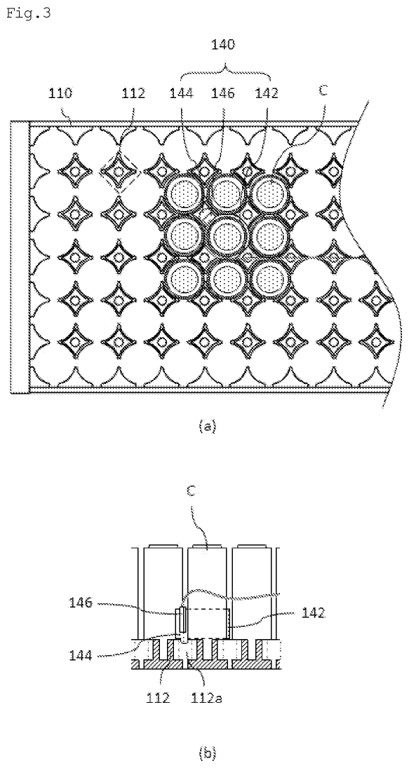

FIGS. 3 A and 3B are views visually illustrating the arrangement position of an extended part 144 of the temperature sensor 140 fixed to the battery unit 100 with the internal temperature monitoring means according to the exemplary embodiment of the present disclosure.

Referring to FIGS. 1 to 3B, the temperature sensor 140 may be provided in a ring shape surrounding the outside of at least one battery cell C among the plurality of battery cells C located in the inner space formed by the lower housing 110 and the upper housing 120 coupled to each other. The temperature sensor 140 may sense the temperature in the inner space formed by the lower housing 110 and the upper housing 120, and may include a coupling part 142, the extended part 144, and a sensor part 146.

The coupling part 142 may be provided in a “C” shape, and may be fitted over and coupled to the battery cell C while surrounding the outside of the battery cell C. The extended part 144 may protrude and extend from the outside of the coupling part 142 in the horizontal direction, and may have a predetermined insertion recess into which the sensor part 146 which will be described later is inserted. The sensor part 146 may be inserted into the insertion recess formed in the extended part 144, and may sense a temperature.

Referring to FIGS. 3A and 3B, the coupling part 142 may be provided to have a thickness less than the interval between the battery cell C to be coupled and another battery cell C adjacent thereto in the row or column direction, so that when the coupling part 142 is fitted over and coupled to the battery cell C, interference with the adjacent battery cell C may not occur. In addition, when the coupling part 142 is fitted over and coupled to a specific battery cell C while surrounding the outside of the battery cell C, as illustrated in FIG. 3A, the coupling may be achieved in such a manner that the extended part 44 faces a battery cell C located in the diagonal direction. Such an arrangement position of the extended part 144 may be due to the configuration of the plurality of protrusions 120 by which the plurality of battery cells C are supportedly arranged in the lower housing 110 so that the interval therebetween in the diagonal direction is greater than those in the row and column directions. To secure a predetermined space for installing the sensor part 146, the extended part 144 has to be positioned in the inner space formed by the lower housing 110 and the upper housing 120 by the coupling part 142 in a region which a relatively large space can be secured. At this time, the extended part 144 may be formed to protrude to a height smaller than the diagonal width of the protrusions 112 formed on the lower housing 110. The coupling part 142 may be fitted over and coupled to the battery cell C while surrounding the outside thereof in a state in which the extended part 144 is positioned on top of the protrusions 112. Thus, the sensor part 146 which will be described later may be fixed in the inner space formed by the lower housing 110 and the upper housing 120 without interference with the adjacent battery cell C. In addition, illustrated in FIGS. 3B, a part of a lower portion of the extended part 144 facing the circulation hole 112-a formed in the protrusion 112 may protrude in the direction of the circulation hole 112-a. Thus, even when the coupling part 142 is rotated as the battery cell C is rotated in a state in which the coupling part 142 is coupled to the battery cell C, the lower portion of the extended part 144 may be caught and fixed in the circulation hole 112-a, thereby preventing the extended part 144 from rotating and colliding with the adjacent battery cell C in a space surrounded by the battery cells C and thus preventing the adjacent battery cell C from being damaged or the sensor part 146 from being separated.

According to the battery unit with the internal temperature monitoring means according to the present disclosure, since the coupling part having a thickness less than the minimum interval between the battery cells is coupled to the battery cell in a state in which the extended part is positioned in the space formed between the battery cells, the sensor part is fixed at a position near the battery cell in the inner space formed by the lower housing and the upper housing coupled to each other. Thus, it is possible to enable precise temperature monitoring to be performed according to the degree of heat generated by the battery cells of the battery unit and the cooling performance, without the need for securing an additional installation space required for internal temperature monitoring.

Although a preferred embodiment of the present disclosure has been described for illustrative purposes, those skilled in the art will appreciate that various modifications, additions and substitutions are possible, without departing from the scope and spirit of the present disclosure as disclosed in the accompanying claims.

What is claimed is:

1. A battery unit in which a plurality of cylindrical battery cells, each of which has an upper surface provided with a positive electrode and a negative electrode, are mounted in rows and columns, the battery unit comprising:
a lower housing in which a plurality of support recesses, each of which supports each of the plurality of battery cells while surrounding a lower surface of the battery cell and a portion of an outer periphery of the battery cell close to the lower surface, are formed in rows and columns and are spaced apart from each other;
an upper housing coupled to top of the lower housing and having a plurality of straight removal regions in which regions corresponding to the respective upper surfaces of the plurality of battery cells supported in the lower housing are connected to each other;
an electrode network provided on an upper surface of the upper housing and provided as a plurality of busbars selectively connected to the respective positive electrodes of the plurality of battery cells exposed through the removal regions; and
a temperature sensor provided in a ring shape coupled to at least one battery cell of the plurality of battery cells while surrounding an outside thereof, and configured to sense a temperature in an inner space formed by the lower housing and the upper housing.

2. The battery unit of claim 1, wherein the lower housing comprises:
a tray part provided in a quadrangular tray shape having an open upper surface having an inner space in which the plurality of battery cells are arranged; and
a plurality of rhombic protrusions protruding upward from a bottom surface of the inner space of the tray part.

3. The battery unit of claim 2, wherein the plurality of protrusions are spaced apart from each other at a predetermined interval to form rows and columns, and at least two or more adjacent protrusions form each of the support recesses,
wherein the support recesses support the battery cells in contact with the portion of the outer periphery of each of the battery cells close to the lower surface thereof.

4. The battery unit of claim 3, wherein the plurality of protrusions have a predetermined thickness in row and column directions so that a specific battery cell and another battery cell adjacent in the row or column direction to the specific battery cell are supported in a state of being spaced apart from each other at a regular interval.

5. The battery unit of claim 4, wherein the temperature sensor comprises:
a coupling part provided in a “C” shape, and fitted over and coupled to the outside of the battery cell;
an extended part protruding from an outside of the coupling part in a horizontal direction, and having a predetermined insertion recess; and
a sensor part inserted into the insertion recess formed in the extended part, and configured to sense the temperature.

6. The battery unit of claim 5, wherein the coupling part has a thickness less than an interval between the battery cell to be coupled and another battery cell adjacent thereto in the row or column direction.

7. The battery unit of claim 6, wherein the extended part protrudes to a height smaller than a diagonal width of the protrusions formed on the lower housing.

8. The battery unit of claim 7, wherein the coupling part is fitted over and coupled to the battery cell while surrounding the outside thereof in a state in which the extended part is positioned on top of the protrusions.
